(19) United States
(12) Patent Application Publication
(10) Pub. No.: US 2016/0047206 A1
(43) Pub. Date: Feb. 18, 2016

(54) METHODS OF SELECTING BOTTOM HOLE ASSEMBLIES COMPRISING EARTH-BORING TOOLS, OF IMPROVING DRILLING OPERATIONS, AND OF IMPROVING DRILLING PLANS BASED ON DRILLING SIMULATIONS

(71) Applicant: Baker Hughes Incorporated, Houston, TX (US)

(72) Inventors: Chaitanya K. Vempati, Conroe, TX (US); Reed W. Spencer, Spring, TX (US); Eric C. Sullivan, Houston, TX (US)

(21) Appl. No.: 14/462,264

(22) Filed: Aug. 18, 2014

(51) Int. Cl. E21B 41/00; G06F 17/50

(52) U.S. Cl. CPC E21B 41/0092; G06F 17/5009

(57) ABSTRACT

Methods of evaluating performance of simulated drilling operations may involve accepting characteristics of an earth formation. A drill path, a plurality of quality evaluation standards, and selection of a bottom hole assembly (BHA) and at least one earth-boring tool may be accepted. A drilling operation attempting to follow the drill path using the BHA and the drill bit may be simulated. Performance of the BHA and the drill bit in the drilling operation may be evaluated relative to the quality evaluation standards. At least one aspect of the simulated drilling operation may be changed, and simulation of the drilling operation, performance evaluation, and change of the aspects of the drilling operation may be iterated. Performance of each drilling operation may be compared to the other drilling operations, and an improved aspect of a drilling operation may be output relative to the comparative performance of the drilling operations.

### FIELD

This disclosure relates generally to bottom hole assemblies comprising earth-boring tools and methods of selecting, designing, and improving bottom hole assemblies and of improving drilling operations and plans for drilling based on drilling simulations. More specifically, disclosed embodiments relate to methods of better evaluating performance of earth-boring tools and bottom hole assemblies and improving drilling operations based on comparative, simulated performance.

### BACKGROUND

When boring in an earth formation, a predetermined drill path extending into the earth formation may be provided for an operator to follow. The drill path may curve, turn, or otherwise be nonlinear, requiring the operator to control a direction in which an earth-boring tool proceeds into the earth formation. Components for inclusion in a drill string, such as a bottom hole assembly (BHA) and one or more earth-boring tools (e.g., an earth-boring drill bit, a reamer, or another tool configured to remove earth material when forming or enlarging a borehole), may be selected for their ability to perform within, and to create, a nonlinear borehole. For example, computer software may be used to simulate a drilling operation and evaluate whether a BHA, an earth-boring tool, or a BHA and an earth-boring tool are capable of moving laterally a predetermined distance per given vertical distance, known in the art as “buildup rate” (BUR), for directional drilling. In addition, operators may alter the operating parameters of a drilling operation (e.g., weight on bit, torque, flow rate of drilling fluid, side forces acting on the drill string, and orientation of the earth-boring tool) to cause the BHA to exhibit a selected BUR.

### BRIEF SUMMARY

In some embodiments, methods of selecting earth-boring tools for drill strings may involve accepting at a processor information representing characteristics of an earth formation. The processor may accept information defining a drill path extending into the earth formation, a plurality of quality evaluation standards, and selection of a first bottom hole assembly (BHA) and a first drill bit. The processor may simulate a first drilling operation attempting to follow the drill path using the first BHA and the first drill bit. Performance of the first BHA and the first drill bit in the first drilling operation may be evaluated based on the quality evaluation standards. The processor may accept selection of a second, different BHA, a second, different drill bit, or the second, different BHA and the second, different drill bit. The processor may simulate a second drilling operation attempting to follow the drill path using the second BHA and the first drill bit, the first BHA and the second drill bit, or the second BHA and the second drill bit. The processor may evaluate performance of the second BHA and the first drill bit, the first BHA and the second drill bit, or the second BHA and the second drill bit in the second drilling operation relative to the quality evaluation standards. The processor may compare performance of the first BHA and the first drill bit in the first drilling operation to the performance of the second BHA and the first drill bit, the first BHA and the second drill bit, or the second BHA and the second drill bit in the second drilling operation. The processor may output a BHA and drill bit combination to deploy in a drill string responsive to the comparative performance of the first BHA and the first drill bit to the performance of the second BHA and the first drill bit, the first BHA and the second drill bit, or the second BHA and the second drill bit.

In other embodiments, methods of improving drilling operations may involve accepting at a processor input from at least one sensor indicating characteristics of an earth formation being drilled by a BHA and a drill bit. The processor may accept information defining a predetermined drill path extending into the earth formation, selection of the BHA and the drill bit used to drill the earth formation, input from at least one sensor indicating an actual drill path of the borehole being drilled in the earth formation, input from at least one sensor indicating operating parameters employed when drilling the earth formation, and a plurality of quality evaluation standards. The processor may simulate a first drilling operation attempting to follow the drill path using the BHA and the drill bit and sensed operating parameters. Performance of the BHA and the drill bit in the first drilling operation may be evaluated based on the quality evaluation standards. The processor may simulate a second drilling operation attempting to follow the drill path using at least one simulated change in operating parameters from the sensed operating parameters. Performance of the BHA and the drill bit in the second drilling operation may be evaluated relative to the quality evaluation standards. The processor may compare performance of the BHA and first drill bit in the first drilling operation to the performance of the BHA and the drill bit in the second drilling operation. The processor may output a change in one or more operating parameters to follow as a drilling plan responsive to the comparative evaluation of the first drilling operation to the second drilling operation.

In still other embodiments, methods of improving plans for drilling boreholes in earth formations may involve accepting at a processor an input indicating characteristics of an earth formation. The processor may accept information defining a drill path extending into the earth formation, a plurality of quality evaluation standards, and selection of a BHA and a drill bit. The processor may determine a first sequence of operating parameters used during a first simulated drilling operation attempting to follow the drill path using the BHA and the drill bit. Performance of the BHA and the drill bit in the first simulated drilling operation may be evaluated relative to the quality evaluation standards. The processor may determine a second, different sequence of operating parameters used during a second simulated drilling operation attempting to follow the drill path using the BHA and the drill bit. Performance of the BHA and the drill bit in the second simulated drilling operation may be evaluated relative to the quality evaluation standards. The processor may compare performance of the BHA and first drill bit in the first drilling operation to the performance of the BHA and the drill bit in the second drilling operation. The processor may output a sequence of operating parameters to follow as a drilling plan based on the comparative evaluation of the first drilling operation to the second drilling operation.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a flowchart diagram of a method of selecting a bottom hole assembly (BHA) and earth-boring tool to deploy in a borehole, of generating and improving a drilling plan, and of improving actual drilling;

FIG. 2 is a schematic view of a drilling assembly configured to drill into an earth formation and practice some methods of FIG. 1; and

FIG. 3 is a block diagram of a computing system configured to practice some methods of FIG. 1.

### DETAILED DESCRIPTION

The illustrations presented in this disclosure are not meant to be actual views of any particular act in a method, drill string, computing system, or component thereof, but are merely idealized representations employed to describe illustrative embodiments. Thus, the drawings are not necessarily to scale.

Disclosed embodiments relate generally to methods of better evaluating performance of BHAs comprising earth-boring tools, and improving drilling operations based on comparative, simulated performance of BHAs comprising different components. More specifically, disclosed are embodiments of methods of evaluating performance of simulated drilling operations of different BHAs based on a plurality of performance evaluation standards and improving component selection and drilling operations based on the comparative performance of the different BHAs in simulated drilling operations through the same subterranean formation.

As used in this disclosure, the term “drilling operation” means and includes any operation performed during the formation or enlargement of a borehole in a subterranean formation. For example, drilling operations include drilling, reaming, and other formation removal processes.

The term “earth-boring tool,” as used in this disclosure, means and includes any type of tool used for earth removal during the formation or enlargement of a borehole in a subterranean formation and include, for example, fixed cutter (i.e., “drag”) bits, roller cone bits, percussion bits, core bits, eccentric bits, bicenter bits, reamers, mills, hybrid bits, and other drilling bits and tools known in the art.

Selecting components for a drill string based solely on their ability to exhibit a predetermined BUR may result in a borehole or a drilling operation that could be improved. For example, BHAs including earth-boring tools and that are capable of exhibiting or exceeding a predetermined BUR may tend to wander off the predetermined drill path (i.e., may walk or spiral), may not be capable of forming a borehole of a predetermined total radius (i.e., may not be able to handle a particular dog leg severity), may proceed slowly (i.e., may exhibit a low rate of penetration (ROP), or may unnecessarily drag against walls of the borehole when deployed in a borehole together. Accordingly, the drilling operation may require directional corrections, may not follow a planned total curvature, may take an excessively long time, and may consume excessive energy.

Similarly, selecting operating parameters for a drilling operation, such as, for example, weight on bit (WOB), torque, flow rate of drilling fluid, magnitude and direction of side forces acting on the drill string (e.g., through control of a steerable BHA), orientation of the earth-boring tool, and when to rotate (i.e., to rotate the entire drill string at the surface) and slide (i.e., to rotate only a portion of the drill string (e.g., a drill bit) using a downhole motor of the BHA), based solely on their ability to conform to a predetermined BUR may similarly result in a drilling operation that could be improved in terms of ROP, a borehole that could be improved in terms of quality, or both. For example, the selected operating parameters may cause the drill string to walk or spiral, to otherwise deviate from the predetermined drill path, to proceed undesirably slowly, or to require input of unnecessarily high quantities of energy. Accordingly, such a drilling operation as conventionally conducted may require directional corrections, may not follow a planned drill path, may take excessive time, and may consume excessive power.

According to embodiments of the disclosure, to improve component selection for a drill string BHA and operating parameter control for a drilling operation, BHA components may be varied, aspects of a drilling operation using BHAs comprising different components may be varied, the drilling operation through the same subterranean formation or formations may be iteratively simulated, and each simulated drilling operation may be more comprehensively evaluated and compared to determine which combination of BHA components is better suited to deploy in one or more subterranean formations corresponding to the simulation to achieve optimal correspondence to a predetermined drill path. Each simulated drilling operation may also be evaluated to determine which operating parameters should be used to implement a plan for drilling along the predetermined drill path. The resulting drilling operations performed using the BHA demonstrating the best performance in comparative simulations and operating parameters selected using the comparative simulations may consume less energy, take less time, decrease wear of the components of the BHA, and produce a higher-quality borehole (e.g., a borehole with fewer deviations from the planned trajectory, a smoother wall surface, and a more consistent diameter).

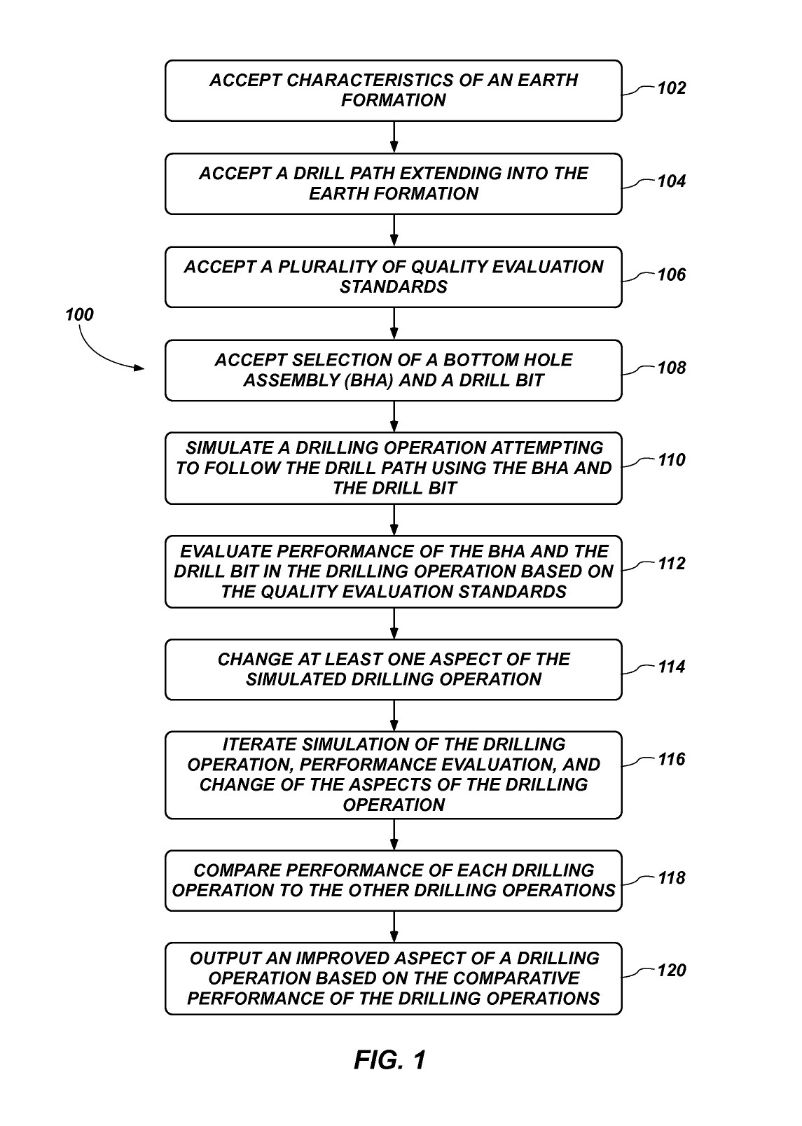

Referring to FIG. 1, a flowchart diagram of a method 100 of selecting a BHA comprising an earth-boring tool to deploy in a borehole, of generating and improving a drilling plan, and of improving actual drilling is shown. The method may involve accepting characteristics of an earth formation (such term as used herein including one or more regions of different rock), as indicated at operation 102. For example, the lithology of the earth formation may be accepted. More specifically, the composition and dimensions of each distinct region of the earth formation may be accepted. In some embodiments, detailed information regarding the characteristics of the earth formation, such as, for example, the type of rock, density, grain size, degree of saturation with fluid and type of fluid saturation, temperature, etc., may be accepted. In other embodiments, generalized information regarding the characteristics of the earth formation, such as, for example, only the type of rock, may be accepted.

The characteristics of the earth formation may be accepted at a processor to be used in a simulation of a drilling operation. For example, the characteristics of the earth formation may be entered by a user via a user interface device and accepted at the processor. As another example, the characteristics of the earth formation may be measured using sensors deployed in a borehole during, for example, drilling of an actual well through the same formation, and accepted at the processor. As yet another example, the characteristics of the earth formation may be extrapolated using the processor by accessing a database of characteristics of geographically closest earth formations and accepting estimated characteristics of the earth formation (e.g., using linear, polynomial, or other known extrapolation techniques) at the processor.

In some embodiments, a measure of the degree of variability in the characteristics of the earth formation or a measure of the degree to which the characteristics of the earth formation are unknown may be accepted. For example, the measure of the degree of variability or the degree of “unknowability” of the characteristics of the earth formation may be ±20%. More specifically, the measure of the degree of variability or the degree of unknowability of the characteristics of the earth formation may be, for example, ±15%. As a specific, nonlimiting example, the measure of the degree of variability or the degree of unknowability of the characteristics of the earth formation may be ±10%. The measure of the degree of variability or the degree of unknowability of the characteristics of the earth formation may enable a series of drilling operations to be simulated in similar earth formations exhibiting different characteristics, which may enable selection of components for a drill string and usage of operating parameters that will better follow the drill path despite changes and variations in characteristics in the actual earth formation being drilled.

The measure of the degree of variability or the degree of unknowability of the characteristics of the earth formation may be accepted at the processor to be used in a simulation of a drilling operation. For example, the degree of variability or the degree of unknowability of the characteristics of the earth formation may be entered by a user via a user interface device and accepted at the processor. As another example, the degree of variability or the degree of unknowability of the characteristics of the earth formation may be extrapolated using the processor by accessing a database of characteristics of geographically closest earth formations and accepting estimated characteristics of the earth formation (e.g., using linear, polynomial, or other known extrapolation techniques) at the processor.

A drill path extending into the earth formation may be accepted, as indicated at operation 104. The drill path may be a predetermined trajectory for a borehole to be drilled, extended or enlarged within the earth formation. More specifically, the drill path may be directionally and dimensionally defined in three-dimensional space for a simulated drilling operation and, optionally, as a plan for an actual drilling operation. The drill path may be nonlinear, and may include curves and turns from vertical (i.e., deviations from a line intersecting the center of the earth) and from horizontal (i.e., deviations from a line tangent to the surface of the earth at the same radial position as the drill path).

The drill path may be accepted at the processor to be used in a simulation of a drilling operation. For example, the drill path may be entered by a user via a user interface device and accepted at the processor. As another example, the drill path may be may be automatically generated using the processor by accessing a database of undrilled earth formations and defining a drill path into an undrilled earth formation proximate a desired resource (e.g., oil).

A plurality of quality evaluation standards may be accepted, as indicated at operation 106. The quality evaluation standards may define the metrics by which the efficiency and borehole quality of a simulated drilling operation will be evaluated. By evaluating a simulated drilling operation using a plurality of quality evaluation standards, the selection of components for drilling operations and operating parameters used during a drilling operation may be improved. For example, the resulting drilling operations may take less time and less energy input and produce higher quality and more accurate boreholes. The quality evaluation standards may include, for example, at least some of ROP, total drilling time, total elapsed time (e.g., including drilling and tripping a drill string into and out of the borehole), ratio of time spent rotating the entire drill string to time spent rotating only a portion of the drill string, total tool wear, BUR, borehole wall smoothness, maximum variation in borehole diameter, number of directional corrections, maximum deviation from the drill path, and ability to drill an acceptable borehole through earth formations exhibiting different characteristics.

The quality evaluation standards may be accepted at the processor to evaluate a simulation of a drilling operation. For example, the quality evaluation standards may be entered by a user via a user interface device and accepted at the processor. As another example, the quality evaluation standards may be automatically selected using the processor from a default set of quality evaluation standards. In some embodiments, each quality evaluation standard may be accepted and used. In other embodiments, some of the quality evaluation standards may not be used.

In some embodiments, a prioritization of each accepted quality evaluation standard relative to the other accepted quality evaluation standards may be accepted. For example, the accepted evaluation standards may be ranked from most important to least important. As another example, a percentage may be assigned to each accepted quality evaluation standard, the percentages totaling 100. Prioritizing the accepted quality evaluation standards may enable selection of components for a drill string and usage of operating parameters for a drilling operation to better meet the highest-priority quality evaluation standards while accounting for the lower-priority quality evaluation standards.

Prioritization of the quality evaluation standards may be accepted at the processor. For example, the prioritization may be entered by a user via a user interface device and accepted at the processor. As another example, the prioritization may be automatically selected using the processor from a default prioritization scheme.

Selection of a BHA comprising at least one earth-boring tool may be accepted, as indicated at operation 108. For example, selection of a BHA, including a downhole motor (e.g., a Moineau-type motor), a directional drilling control device, and an earth-boring drill bit may be accepted for a simulated drilling operation attempting to follow the accepted drill path. More specifically, selection of a BHA and an earth-boring tool from, for example, a set of predefined BHAs and earth-boring tools, including information relating to the length, features, configuration, operation, and drilling behavior of the BHAs and earth-boring tools of the set, may be accepted. In other embodiments, a first BHA comprising an earth-boring tool may be accepted for a first simulated drilling operation, and BHA components, including an earth-boring tool, may be altered responsive to results of the first simulation.

Selection of the BHA and earth-boring tool or tools may be accepted at the processor. For example, the selection may be entered by a user via a user interface device and accepted at the processor. As another example, the selection may be automatically made using the processor by comparing the known information about the predefined BHAs and earth-boring tools to the known requirements of the drilling operation (e.g., characteristics of the drill path, characteristics of the earth formation to be drilled, and tendencies of the BHAs and earth-boring tools). As yet another example, sensors or identification markers (e.g., RFID tags) may automatically transmit the selection of the BHA and the earth-boring tool or tools for acceptance at the processor.

In some embodiments, ranges for operating parameters to be used when simulating drilling through the earth formation along the drill path may be accepted. For example, ranges for operating parameters selected from at least some of WOB, WOB when rotating an entire drill string, WOB when rotating only a portion of the drill string, torque, torque when rotating the entire drill string, torque when rotating only the portion of the drill string, flow rate of drilling fluid, side forces acting on the drill string, and orientation of the earth-boring tool may be accepted. The ranges may reflect, for example, outer limits for operating parameters used with the equipment used for drilling or the one or more standard deviations from average operating parameters actually used and recorded in the field with the equipment used for drilling. In some embodiments, ranges for each operating parameter may be accepted. In other embodiments, ranges for only some of the operating parameters may be accepted.

Ranges of the operating parameters may be accepted at the processor. For example, the ranges of the operating parameters may be entered by a user via a user interface device and accepted at the processor. As another example, the ranges of the operating parameters may be automatically determined using the processor by statistically analyzing operating parameters actually used and recorded in the field with the equipment used for drilling. As yet another example, sensors may automatically transmit the ranges of operating parameters actually used during a drilling operation for acceptance at the processor.

A drilling operation attempting to follow the drill path using the BHA and the drill bit may then be simulated, as indicated at operation 110. For example, three-dimensional models of the drill string, the earth formation, and the drill path may be constructed and the movement of, forces acting on, and dynamic response of the drill string and the earth formation may be simulated (e.g., using finite element analysis) using the processor. The simulated path of the drill string may be compared to the predetermined drill path and, if the simulated path deviates from the predetermined drill path by more than a predefined maximum deviation (which may or may not be one of the quality evaluation standards), the simulation may attempt to correct by making changes in a manner similar to the changes a drilling operator would make in the field, such as, for example, by changing one or more operating parameters at selected depth intervals, for example at every 30 feet, 60 feet or 90 feet of borehole penetration. For example, the simulated operating parameters may be automatically changed by consulting a database, which may take the form of a lookup table, of strategies for changing operating parameters to correct for deviations from the drill path and recording each change. In a more sophisticated approach, an inference engine may be developed and employed to implement operating parameter changes using a knowledge base comprising empirical data from decisions on operating parameter selections and changes by directional drillers, and results of such selections and changes, in drilling of prior, actual wells. The operating parameter data and result data may be employed by the inference engine to conduct and alter a simulated drilling operation according to rules developed by the artificial intelligence of the inference engine. The sequence of operating parameters used during the simulated drilling operation may be recorded for use as a potential drilling plan. As a specific, nonlimiting example, the drilling operation may be simulated using the techniques disclosed in U.S. Patent App. Pub. No. 2014/0136138, published May 15, 2014, and titled “DRILL BIT SIMULATION AND OPTIMIZATION,” the disclosure of which is incorporated in this disclosure in its entirety by this reference.

Performance of the BHA and the drill bit in the drilling operation may be evaluated based on the quality evaluation standards, as indicated at operation 112. The nature of the evaluation may depend on the specific standard being evaluated. For example, certain quality evaluation standards, such as, for example, ROP, total drilling time, total elapsed time, ratio of time spent rotating the entire drill string to time spent rotating only a portion of the drill string, total tool wear, BUR, borehole wall smoothness, maximum variation in borehole diameter, number of directional corrections, and maximum deviation from the drill path, may be evaluated by recording or calculating an aspect of the simulated performance of the drilling operation to be used in a subsequent comparison. The performance may be evaluated using the processor and the results stored in memory to be used in when comparing different simulated drilling operations to one another.

At least one aspect of the simulated drilling operation may be changed, as indicated at operation 114. For example, one or more components of the drill string, such as, for example, makeup of the BHA in terms of one or more of length, components, number of components, sequence of components and earth-boring tool, may be changed. More specifically, a second BHA comprising the same components but for a second, different earth-boring tool, or a second BHA comprising the same earth-boring tool as the first BHA but one or more different other components may be selected. As another example, the operating parameters or the sequence of operating parameters may be changed. More specifically, the values of the operating parameters used and when they are deployed at those values may be different from the values or times of deployment used during the first simulated drilling operation. As yet another example, the characteristics of the earth formation into which the drill path extends may be changed. More specifically, the composition of material being drilled, the dimensions (e.g., thickness or length) of one or more of the regions of material being drilled, or both may be changed. As still another example, the drill path may be changed. More specifically, the destination or the route taken to the destination when defining the drill path may be changed.

The aspect or aspects of the simulated drilling operation may be changed at the processor. For example, the aspect or aspects of the simulated drilling operation may be entered by a user via a user interface device and changed at the processor. As another example, the aspect or aspects of the simulated drilling operation may be automatically changed using the processor by, for example, randomly selecting a new aspect or by selecting a next-closest option from a database of options.

Simulation of the drilling operation 110, performance evaluation 112, and change of the aspects of the drilling operation 114 may be iterated, as indicated at operation 116, to generate a plurality of different, simulated drilling operations attempting to access a common resource or achieve a common goal. The results of each simulated drilling operation may be stored (e.g., in memory) for comparative evaluation of the simulated drilling operations. Iteration may involve any number of changes and any number of total simulations. For example, only a single aspect may be changed, and only two drilling operations may be simulated for a direct evaluation of that change. As another example, multiple changes may be made to a single aspect of the BHA or to a single operating parameter, and a corresponding number of drilling operations may be simulated for an evaluation of how the different changes affect that aspect of the drilling operation. As yet another example, multiple changes may be made to multiple aspects of the BHA and/or operating parameters, and a corresponding number of drilling operations may be simulated for a more comprehensive evaluation of how to improve a drilling operation.

Performance of each drilling operation may be compared to the other drilling operations, as indicated at operation 118. For example, the results of evaluating the performance evaluation standards may be compared to one another. More specifically, the result of each performance evaluation standard may be compared to the corresponding results for that performance evaluation standard. As a specific, nonlimiting example, each simulated drilling operation may be ranked against each other simulated drilling operation for each performance evaluation standard and a master ranking of the drilling operations based on each individual ranking may be produced. As another example, the simulated drilling operations may be compared to one another based on the performance evaluation standards and the prioritization of those standards. More specifically, a weight may be assigned to each quality evaluation standard based on the prioritization, each quality evaluation standard outcome may be multiplied by its associated weight, and a composite evaluation value may be generated.

An improved aspect of a drilling operation may be output based on the comparative performance of the drilling operations, as indicated at 120. For example, the output may be a BHA comprising an earth-boring tool best suited to perform the drilling operation when compared to the BHAs comprising earth-boring tools from the other simulated drilling operations or to previously conducted actual drilling operations. As another example, the output may be a series of operational parameters (e.g., a drilling plan for an operator to follow) best suited to follow the drill path when compared to the sequences of other operational parameters from the other simulated drilling operations or to previously conducted actual drilling operations.

The method 100 may be performed, for example, when selecting components for a drill string BHA to be deployed for a drilling operation. As a result, a better and more comprehensive evaluation of potential components and component combinations for a BHA may be made at less expense and faster than using empirical data. The method 100 may be performed, for example, when determining how to perform a drilling operation. As a result, a better plan for drilling and a better drill path may be defined to reach the desired objective. Finally, the method 100 may be performed, for example, during the course of an actual drilling operation (e.g., while a borehole is being drilled) to predict deviations from the well plan. As a result, drilling operators may better determine how to operate the equipment to follow the drill path and correct for deviations from the drill path.

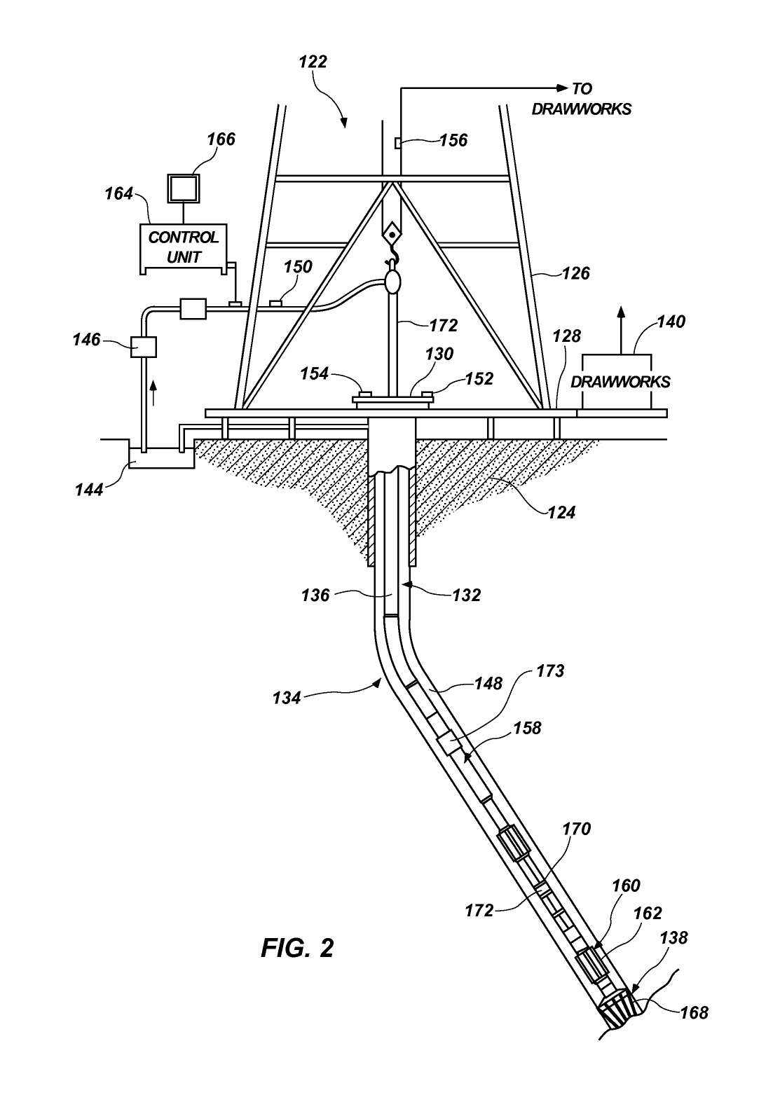

FIG. 2 is a schematic view of a drilling assembly 122 configured to drill into an earth formation 124 and practice some of the methods 100 described previously in connection with FIG. 1. The drilling assembly 122 may include a derrick 126 erected on a floor 128, which may support a rotary table 130 rotated by a prime mover such as an electric motor at a desired rotational speed. A drill string 132 supported by the derrick 126 and deployed in a borehole 134 in the earth formation 124 may include drill pipe 136 extending downward from the rotary table 130 into the borehole 134. A drill bit 138 located at an end of the drill string 132 may engage with the earth formation 124 when it is rotated to drill the borehole 134. The drill string 132 may be coupled to a drawworks 140 (e.g., using a kelly joint 142). During the drilling operation the drawworks 140 may control the WOB.

During drilling operations, a drilling fluid 144 may be circulated under pressure through the drill string 132, and the rate of flow may be controlled by a pump 146. The drilling fluid 144 may be discharged at a bottom of the borehole 134 through openings (e.g., nozzles) in the drill bit 138. The drilling fluid 144 may then flow back up to the surface through the annular space 148 between the drill string 132 and walls of the borehole 134 for recirculation. A sensor 150 (e.g., a flow meter) may provide information about the fluid flow rate of the drilling fluid 144. A surface torque sensor 152 and a rotational rate sensor 154 associated with the drill string 132 respectively may provide information about the torque and the rotational speed of the drill string. Additionally, a sensor 156 associated with the kelly joint 142 may measure the hook load of the drill string 132 to measure or at least approximate the WOB.

The drill bit 138 may be rotated by rotating the entire drill string 132 when drilling certain portions of the borehole 134. In other portions, such as, for example, when changing drilling direction, a downhole motor 158 may rotate the drill bit 138 through a drive shaft extending between the motor 158 and the drill bit 138. A bearing assembly 160 may bear radial and axial forces between the drill string 132 and the walls of the borehole 134 proximate the drill bit 138. A stabilizer 162 coupled to the bearing assembly 160 may, depending upon its configuration (i.e., concentric or eccentric), position the drill bit 138 centrally within the borehole 134 or may bias the drill bit 138 toward a desired direction. The drill bit 138 may contain sensors 168 configured to determine drill bit condition and wear. Sensors 170 and 172 may also be positioned on the drill string 132 and be configured to determine the inclination and azimuth of the drill string 132, the position of drill bit 138, borehole quality, and the characteristics of the formation being drilled. Additional details and equipment for a drilling assembly 122 configured to collect information regarding the characteristics of an earth formation, operational parameters, and equipment used are disclosed in U.S. Patent App. Pub. No. 2014/0136138, published May 15, 2014, and titled “DRILL BIT SIMULATION AND OPTIMIZATION,” the disclosure of which has previously been incorporated in this disclosure in its entirety by reference.

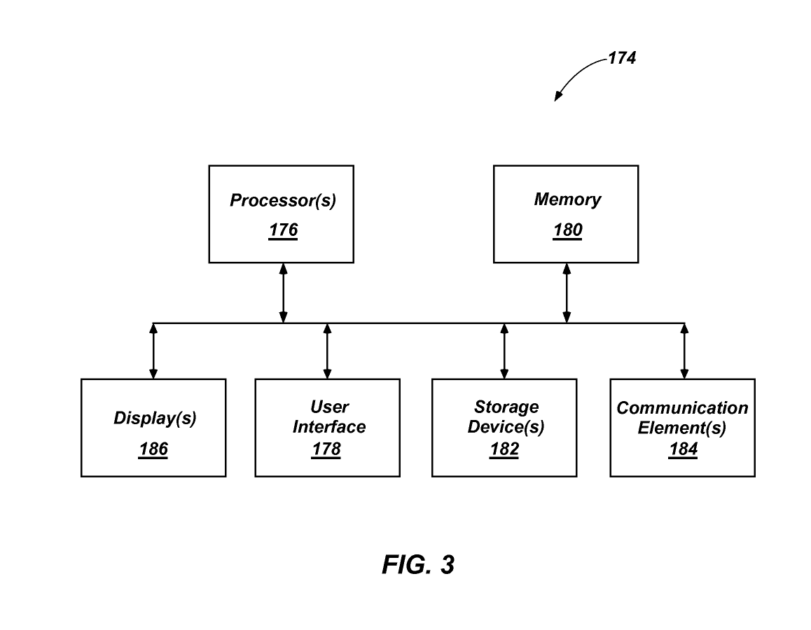

A surface control unit 164 may receive signals from the sensors 150, 152, 154, 156, 168, and 170 and any other sensors used in the drilling assembly 122 and process the signals according to programmed instructions. The sensor signals may be provided at selected time intervals, at depth intervals along the drill path, at reduced intervals during drilling of nonlinear portions of the borehole, or a combination thereof. The surface control unit 164 may display current operating parameters, output recommended operating parameters, and other information on an electronic display 166, which may be utilized by an operator to control the drilling operations. The surface control unit 164 may be a computing system, as described in greater detail in connection with FIG. 3. The surface control unit 164 may be configured to accept inputs (e.g., via the sensors 150, 152, 154, 156, 168, and 170 or via a user input device) and execute the methods 100 described previously in connection with FIG. 1, including simulating drilling operations, to improve aspects of an active drilling operation through corrective measures comprising alteration of operating parameters, to provide recommendations for equipment selection and operation for a subsequent, planned drilling operation, or both.

In other embodiments, a downhole control unit 173 may receive the signals from the sensors 150, 152, 154, 156, 168, and 170 and any other sensors used in the drilling assembly 122 and process the signals according to programmed instructions. The downhole control unit 173 may send the results of the processed signals (e.g., current downhole conditions, current position, position relative to the predetermined drill path, current operating parameters, recommended operating parameters, current equipment deployed, and recommended equipment for deployment) to the electronic display 166 at the surface, which may be utilized by an operator to control the drilling operations. The downhole control unit 173 may be a computing system, as described in greater detail in connection with FIG. 3. The downhole control unit 173 may be configured to accept inputs (e.g., via the sensors 150, 152, 154, 156, 168, and 170 or via a user input device) and execute the methods 100 described previously in connection with FIG. 1, including simulating drilling operations, to improve aspects of an active drilling operation through corrective measures comprising alteration of operating parameters, to provide recommendations for equipment selection and operation for a subsequent, planned drilling operation, or both.

In one embodiment, one or more simulations of a drill plan may be run concurrently with an actual drilling operation, using the target path of the actual operation in conjunction with the actual drill string, drive system and BHA comprising the selected drill bit and employing the actual WOB and torque applied, as well as known formation lithology. A corrective factor to WOB and torque actually applied to the BHA and drill bit may be employed to account for frictional losses attributable to contact with the wall of the borehole. Current well survey data may also be employed as input. Sensor data received at the surface control unit 164 may be employed to compare the actual drill path to the target path and to the path of the simulation used as a decision support system in a drill ahead scenario in multiple iterations in advance of the actual drill path to predict operating parameter changes which may be implemented to optimize the actual drill path to the target path. Of course, additional simulations may also be concurrently run, using the actual drill path data as the drilling operation progresses, to determine what changes, if any, in selection of the drill bit and other BHA components may be made for drilling of subsequent boreholes through the same formations. Further, if it is necessary to trip out the BHA due to bit or other component wear or failure or for some other purpose, the simulations may be used to predict what BHA changes may be desirable for drilling a subsequent interval.

FIG. 3 is a block diagram of a computing system 174 configured to practice some methods of FIG. 1. The computing system 174 may be a user-type computer, a file server, a computer server, a notebook computer, a tablet, a handheld device, a mobile device, or other similar computer system for executing software. The computing system 174 may be configured to execute software programs containing computing instructions and may include one or more processors 176, memory 180, one or more displays 186, one or more user interface elements 178, one or more communication elements 184, and one or more storage devices 182 (also referred to herein simply as storage 182).

The processors 176 may be configured to execute a wide variety of operating systems and applications including the computing instructions for performing the methods 100 discussed previously in connection with FIG. 1.

The memory 180 may be used to hold computing instructions, data, and other information for performing a wide variety of tasks including administering wagering games of the present disclosure. By way of example, and not limitation, the memory 180 may include Synchronous Random Access Memory (SRAM), Dynamic RAM (DRAM), Read-Only Memory (ROM), Flash memory, and the like.

The display 186 may be a wide variety of displays such as, for example, light emitting diode displays, liquid crystal displays, cathode ray tubes, and the like. In addition, the display 186 may be configured with a touch-screen feature for accepting user input as a user interface element 178.

As nonlimiting examples, the user interface elements 178 may include elements such as displays, keyboards, push-buttons, mice, joysticks, haptic devices, microphones, speakers, cameras, and touchscreens.

As nonlimiting examples, the communication elements 184 may be configured for communicating with other devices or communication networks. As nonlimiting examples, the communication elements 184 may include elements for communicating on wired and wireless communication media, such as for example, serial ports, parallel ports, Ethernet connections, universal serial bus (USB) connections, IEEE 1394 (“firewire”) connections, Thunderbolt™ connections, Bluetooth® wireless networks, ZigBee wireless networks, 802.11 type wireless networks, cellular telephone/data networks, and other suitable communication interfaces and protocols.

The storage 182 may be used for storing relatively large amounts of nonvolatile information for use in the computing system 174 and may be configured as one or more storage devices. By way of example, and not limitation, these storage devices may include computer-readable media (CRM). This CRM may include, but is not limited to, magnetic and optical storage devices such as disk drives, magnetic tape, CDs (compact discs), DVDs (digital versatile discs or digital video discs), and semiconductor devices such as RAM, DRAM, ROM, EPROM, Flash memory, and other equivalent storage devices.

A person of ordinary skill in the art will recognize that the computing system 174 may be configured in many different ways with different types of interconnecting buses between the various elements. Moreover, the various elements may be subdivided physically, functionally, or a combination thereof. As one nonlimiting example, the memory 180 may be divided into cache memory, graphics memory, and main memory. Each of these memories may communicate directly or indirectly with the one or more processors 176 on separate buses, partially-combined buses, or a common bus.

The computing system 174 may be configured to accept inputs (e.g., via the user interface device 178 or other inputs) and execute the methods 100 described previously in connection with FIG. 1, including simulating drilling operations, to improve aspects of an active drilling operation or provide recommendations for equipment selection and operation for a planned drilling operation.

While certain illustrative embodiments have been described in connection with the figures, those of ordinary skill in the art will recognize and appreciate that the scope of this disclosure is not limited to those embodiments explicitly shown and described in this disclosure. Rather, many additions, deletions, and modifications to the embodiments described in this disclosure may result in embodiments within the scope of this disclosure, such as those specifically claimed, including legal equivalents. In addition, features from one disclosed embodiment may be combined with features of another disclosed embodiment while still being within the scope of this disclosure, as contemplated by the inventors.

What is claimed is:

1. A method of selecting earth-boring tools for a drill string, comprising:
accepting at a processor information representing characteristics of an earth formation;
accepting at the processor information defining a drill path extending into the earth formation;
accepting at the processor a plurality of quality evaluation standards;
accepting at the processor selection of a first bottom hole assembly (BHA) and a first drill bit;
simulating at the processor a first drilling operation attempting to follow the drill path using the first BHA and the first drill bit;
evaluating performance of the first BHA and the first drill bit in the first drilling operation relative to the quality evaluation standards;
accepting at the processor selection of a second, different BHA, a second, different drill bit, or the second, different BHA and the second, different drill bit;
simulating at the processor a second drilling operation attempting to follow the drill path using the second BHA and the first drill bit, the first BHA and the second drill bit, or the second BHA and the second drill bit;
evaluating at the processor performance of the second BHA and the first drill bit, the first BHA and the second drill bit, or the second BHA and the second drill bit in the second drilling operation relative to the quality evaluation standards;
comparing at the processor performance of the first BHA and the first drill bit in the first drilling operation to the performance of the second BHA and the first drill bit, the first BHA and the second drill bit, or the second BHA and the second drill bit in the second drilling operation; and
outputting from the processor a BHA and drill bit combination to deploy in a drill string responsive to the comparative performance of the first BHA and the first drill bit to the performance of the second BHA and the first drill bit, the first BHA and the second drill bit, or the second BHA and the second drill bit.

2. The method of claim 1, wherein accepting the plurality of quality evaluation standards comprises accepting a plurality of quality evaluation standards selected from a group comprising at least some of rate of penetration, total drilling time, total elapsed time, ratio of time spent rotating the entire drill string to time spent rotating only the first BHA, total tool wear, build up rate of the first BHA and the first drill bit, borehole wall smoothness, maximum variation in borehole diameter, number of directional corrections, maximum deviation from the drill path, and ability to drill an acceptable borehole through earth formations exhibiting different characteristics from the input characteristics of the earth formation.

3. The method of claim 1, further comprising accepting at the processor a prioritization of each quality evaluation standard relative to the other quality evaluation standards.

4. The method of claim 3, wherein outputting from the processor the BHA and drill bit combination to deploy in the drill string responsive to the comparative performance of the first BHA and the first drill bit to the performance of the second BHA and the first drill bit, the first BHA and the second drill bit, or the second BHA and the second drill bit comprises assigning a weight to each quality evaluation standard based on the prioritization, multiplying each quality evaluation standard outcome by its associated weight, determining a composite evaluation value for the first BHA and the first drill bit and for the second BHA and the first drill bit, the first BHA and the second drill bit, or the second BHA and the second drill bit, and outputting the BHA and drill bit combination having the highest composite evaluation value.

5. The method of claim 1, further comprising accepting at the processor ranges for operating parameters to be used when simulating drilling through the earth formation along the drill path.

6. The method of claim 5, wherein accepting at the processor the ranges for the operating parameters comprises accepting ranges for operating parameters selected from a group comprising weight on bit (WOB), WOB when rotating an entire drill string, WOB when rotating only the first drill bit using the first BHA, torque, torque when rotating the entire drill string, torque when rotating only the first drill bit using the first BHA, flow rate of drilling fluid, side forces acting on the first BHA and the first drill bit, and orientation of the first drill bit.

7. The method of claim 5, wherein accepting at the processor the ranges for the operating parameters comprises generating at the processor the ranges for the operating parameters by accessing a database comprising operating parameters used for the same or similar BHAs and drill bits in the same or similar earth formations and selecting operating parameters corresponding to the most similar BHA, drill bit, and earth formation.

8. The method of claim 1, further comprising:
changing at least one of the characteristics of the earth formation, operating parameters used during the simulation, and the characteristics of the earth formation and the operating parameters used during the simulation;
simulating at the processor another drilling operation attempting to follow the drill path using the first BHA and the first drill bit;
evaluating performance of the first BHA and the first drill bit in the other drilling operation relative to the quality evaluation standards;
comparing at the processor performance of the first BHA and the first drill bit in the first drilling operation to the performance of the first BHA and the first drill bit in the other drilling operation; and
outputting from the processor a sequence of operating parameters to follow as a drilling plan responsive to the comparative performance of the first drilling operation to the other drilling operation.

9. The method of claim 1, wherein simulating the first drilling operation comprises automatically changing operating parameters based on a database of strategies for changing operating parameters to correct for deviations from the drill path and recording each change.

10. The method of claim 1, wherein accepting at the processor the selection of the first BHA and the first drill bit comprises accepting from a user input device selection of the first BHA and the first drill bit from a plurality of BHAs and a plurality of drill bits.

11. The method of claim 1, wherein accepting at the processor the selection of the first BHA and the first drill bit comprises automatically selecting at the processor the first BHA and the first drill bit from a plurality of BHAs and a plurality of drill bits.

12. The method of claim 1, wherein accepting at the processor the information representing the characteristics of the earth formation comprises extrapolating at the processor the information representing the characteristics of the earth formation from a database of known characteristics of geographically closest earth formations.

13. A method of improving a drilling operation, comprising:
accepting at a processor input from at least one sensor indicating characteristics of an earth formation being drilled by a BHA and a drill bit;
accepting at the processor information defining a predetermined drill path extending into the earth formation;
accepting at the processor selection of the BHA and the drill bit used to drill the earth formation;
accepting at the processor input from at least one sensor indicating an actual drill path of the borehole being drilled in the earth formation;
accepting at the processor input from at least one sensor indicating operating parameters employed when drilling the earth formation;
accepting at the processor a plurality of quality evaluation standards;
simulating at the processor a first drilling operation attempting to follow the drill path using the BHA and the drill bit and sensed operating parameters;
evaluating performance of the BHA and the drill bit in the first drilling operation relative to the quality evaluation standards;
simulating at the processor a second drilling operation attempting to follow the drill path using at least one simulated change in operating parameters from the sensed operating parameters;
evaluating performance of the BHA and the drill bit in the second drilling operation relative to the quality evaluation standards;
comparing at the processor performance of the BHA and first drill bit in the first drilling operation to the performance of the BHA and the drill bit in the second drilling operation; and
outputting from the processor a change in one or more operating parameters to follow as a drilling plan responsive to the comparative evaluation of the first drilling operation to the second drilling operation.

14. The method of claim 13, wherein outputting from the processor the change in one or more operating parameters to follow as the drilling plan comprises outputting a sequence of operating parameters to change.

15. The method of claim 13, wherein outputting the one or more operating parameter to change comprises outputting at least one operating parameter selected from a group comprising weight on bit (WOB), WOB when rotating an entire drill string, WOB when rotating only the first drill bit using the first BHA, torque, torque when rotating the entire drill string, torque when rotating only the first drill bit using the first BHA, flow rate of drilling fluid, side forces acting on the first BHA and the first drill bit, and orientation of the first drill bit to change.

16. The method of claim 13, wherein simulating the second drilling operation comprises automatically changing operating parameters based on a database of strategies for changing operating parameters to correct for deviations from the drill path and recording each change.

17. A method of improving a plan for drilling a borehole in an earth formation, comprising:
accepting at a processor an input indicating characteristics of an earth formation;
accepting at the processor information defining a drill path extending into the earth formation;
accepting at the processor a plurality of quality evaluation standards;
accepting at the processor selection of a BHA and a drill bit;
determining using the processor a first sequence of operating parameters used during a first simulated drilling operation attempting to follow the drill path using the BHA and the drill bit;
evaluating performance of the BHA and the drill bit in the first simulated drilling operation relative to the quality evaluation standards;
determining using the processor a second, different sequence of operating parameters used during a second simulated drilling operation attempting to follow the drill path using the BHA and the drill bit;
evaluating performance of the BHA and the drill bit in the second simulated drilling operation relative to the quality evaluation standards;
comparing at the processor performance of the BHA and first drill bit in the first drilling operation to the performance of the BHA and the drill bit in the second drilling operation; and
outputting from the processor a sequence of operating parameters to follow as a drilling plan based on the comparative evaluation of the first drilling operation to the second drilling operation.

18. The method of claim 17, further comprising accepting a prioritization of each quality evaluation standard relative to the other quality evaluation standards.

19. The method of claim 18, wherein outputting from the processor sequence of operating parameters to follow as a drilling plan based on the comparative evaluation of the first drilling operation to the second drilling operation comprises assigning a weight to each quality evaluation standard based on the prioritization, multiplying each quality evaluation standard outcome by its associated weight, determining a composite evaluation value for the first sequence of operation parameters and for the second sequence of operation parameters, and outputting the sequence of operation parameters having the highest composite evaluation value.

20. The method of claim 17, wherein determining the first sequence of operating parameters comprises automatically selecting operating parameters based on a database of strategies for changing operating parameters to correct for deviations from the drill path and recording each change.
